(19) United States
(12) Patent Application Publication
(10) Pub. No.: US 2009/0255628 A1
(43) Pub. Date: Oct. 15, 2009

(54) Micro-article and method of making

(76) Inventors: William J. Miller, Horseheads, NY (US); Vasudha Ravichandran, Painted Post, NY (US)

Correspondence Address: CORNING INCORPORATED, SP-TI-3-1, CORNING, NY, 14831, US

(21) Appl. No.: 12/082,121

(22) Filed: Apr. 9, 2008

(51) Int. Cl. C09J 5/02

(52) U.S. Cl. 156/307.3

(57) ABSTRACT

A method for micro-article assembly, the method including: applying a curable formulation to a first member; curing the applied curable formulation to provide a pressure sensitive adhesive on the first member; and combining, such as applying pressure to the first member having the cured selectively applied pressure sensitive adhesive and a second member to form the microplate assembly and as further defined herein.

The entire disclosure of any publication, patent, or patent document mentioned herein is incorporated by reference.

### BACKGROUND

The disclosure relates to a micro-article and to methods for making and using the micro-article.

### SUMMARY

The disclosure relates to micro-articles or micro-vessels for use, for example, in fluid holding, fluid processing, and fluid analysis, for example, a microplate, a biosensor, a microfluidic cell, a micro-reactor, a culture vessel, and like articles. The disclosure also relates to methods for making and using the micro-articles for accomplishing, for example, label-free assays, and like assays, and microfluidic processes, and like processes.

### BRIEF DESCRIPTION OF THE DRAWING(S)

FIG. 1 is an exemplary schematic for the transformative preparation of a micro-article, in embodiments of the disclosure.

FIG. 2 shows a cross-section of the micro-device of FIG. 1, in embodiments of the disclosure.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments for the claimed invention.

### Definitions

“Biosensor” or like term refers to a device for the detection of, for example, an analyte or a molecular interaction that combines a biological component with a physicochemical detector component. The biosensor typically consists of three parts: a biological component or element (such as tissue, microorganism, pathogen, cells, or combinations thereof), a detector element (operating in a physicochemical manner such as optical, piezoelectric, electrochemical, thermometric, or magnetic), and a transducer associated with both components. The biological component or element can be, for example, a particular surface chemistry, a living cell, a pathogen, or a combination thereof. In embodiments, an optical biosensor can comprise an optical transducer for converting a molecular recognition or molecular stimulation event in a particular surface chemistry, a living cell, a pathogen, or combinations thereof into a quantifiable signal. In embodiments of the disclosure, one or more biosensor can be incorporated into a micro-article.

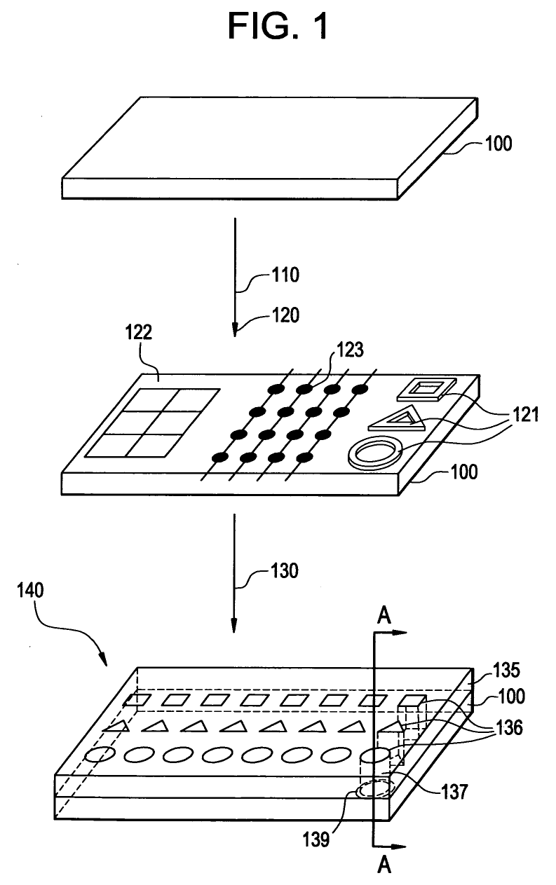

Biosensors are useful tools and some exemplary uses and configurations are disclosed, for example, in PCT Application No. PCT/US2006/013539 (Pub. No. WO 2006/108183), published Dec. 10, 2006, to Fang, Y., et al., entitled “Label-Free Biosensors and Cells,” and U.S. Pat. No. 7,175,980. Biosensor-based cell assays having penetration depths, detection zones, or sensing volumes have been described, see for example, Fang, Y., et al. “Resonant waveguide grating biosensor for living cell sensing,” (2006) Biophys. J., 91, 1925-1940. Microfluidic articles are also useful tools and some exemplary uses, configurations, and methods of manufacture are disclosed, for example, in U.S. Pat. Nos. 6,677,131, and 7,007,709. U.S. Patent Publication 20070141231 and U.S. Pat. No. 7,175,980, disclose a microplate assembly method where the wells include substantial amounts of adhesive bonding material protruding or encroaching into the well volume of the active sensing surface area (see for example FIG. 1 therein).

“Include,” “includes,” or like terms means including but not limited to.

“About” modifying, for example, the quantity of an ingredient in a composition, concentrations, volumes, process temperature, process time, yields, flow rates, pressures, film thickness, and like values, and ranges thereof, employed in describing the embodiments of the disclosure, refers to variation in the numerical quantity that can occur, for example: through typical measuring and handling procedures used for making compounds, compositions, concentrates or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. Whether modified by the term “about” the claims appended hereto include equivalents to these quantities.

“Consisting essentially of” in embodiments refers, for example, to a sensing or micro-article, a method of making or using the article, and can include the components or steps listed in the claim, plus other components or steps that do not materially affect the basic and novel properties of any of the compositions, articles, apparatus, and methods of making and use of the disclosure, such as particular reactants, particular materials, particular additives or ingredients, particular agents, particular surface modifier or surface conditions, or like structure, material, or process variable selected. Items that may materially affect the basic properties of the components or steps of the disclosure or may impart undesirable characteristics to the present disclosure include, for example, excessive or extended curing conditions that can render the cured formulation ineffective as a pressure sensitive adhesive, insufficient or inadequate curing conditions that can render expected cured formulation to be ineffective as a PSA and additionally or alternatively can result in, e.g., well intrusion or connection, inadequate contacting of the first and second members, and like characteristics.

Thus, the claimed invention may suitably comprise, consist of, or consist essentially of, for example, a micro-article as defined herein; and a method for preparing the micro-article as defined herein.

The indefinite article “a” or “an” and its corresponding definite article “the” as used herein means at least one, or one or more, unless specified otherwise.

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, and like abbreviations).

Specific and preferred values disclosed for components, ingredients, additives, reactants, cell types, antibodies, and like aspects, and ranges thereof, are for illustration only; they do not exclude other defined values or other values within defined ranges. The compositions, apparatus, and methods of the disclosure include those having any value or any combination of the values, specific values, more specific values, and preferred values described herein.

In embodiments, the disclosure provides a method for making a micro-article or micro-assembly, the method comprising:

applying a curable formulation to at least one selected area on one side of a first member;

curing the curable formulation to provide a pressure sensitive adhesive at the at least one selected area on the first member; and

contacting the pressure sensitive adhesive bearing side of first member with the side of a second member to form the micro-article.

In embodiments, the disclosure also provides sensing articles prepared by the method and having sensing areas substantially free of adhesive residue or adhesive contamination. The disclosure also provides products that incorporate the sensing articles and methods of using the sensing articles of the disclosure.

In embodiments, the disclosure provides a sensing or micro-article comprising:

a substrate;

a liquid holder portion; and

a discontinuous bonding and sealing layer that unites or joins the substrate and the liquid holder portion forming the sensing or micro-article having sensing areas, the sensing or working areas being substantially free of adhesive residue or adhesive contamination.

In embodiments, the substrate can be, for example, a sensor grating having a biosensor thereon, the liquid holder portion can be, for example, a microtiter plate having a plurality of wells, and the discontinuous bonding and sealing layer can be, for example, a pre-fixed pressure sensitive adhesive.

In embodiments, the disclosure provides a method for making a micro-article assembly, the method comprising:

applying a curable formulation to at least one selected area on one side of a first member;

curing the curable formulation to provide a fixed location pressure sensitive adhesive at the at least one selected area on the first member; and

contacting the pressure sensitive adhesive bearing side of first member with the side of a second member to form the micro-article.

In embodiments, the micro-article can be, for example, a microplate, a biosensor, a microfluidic cell, a micro-reactor, a microtiter plate, and like articles, or a combination thereof. The first member article can be, for example, a liquid holder, a sensor grating, or a combination thereof. The second member article can be, for example, a sensor grating, a liquid holder, or a combination thereof. The curable formulation article can be, for example, a printable precursor of a pressure sensitive adhesive selected from, for example, an acrylate, or like materials, and copolymers thereof. The first member can be made of, for example, a plastic, a polymeric or co-polymeric substance, a ceramic, a glass, a metal, a crystalline material, a noble or semi-noble metal, a metallic or non-metallic oxide, a transition metal, and like materials, or a combination thereof. The second member can be made of, for example, the same or similar materials. In embodiments, the second member can be made of materials dissimilar to the first member.

In embodiments, the liquid contacting surfaces of the liquid holder cavity and the sensor grating area of the resulting micro-article can be substantially free of curable formulation, pressure sensitive adhesive, or a combination thereof.

In embodiments, the application of a curable formulation to at least one selected area on one side of a first member article can include, for example, at least one of screen printing, pad printing, edge printing, pin printing, ink jet printing, jet dispensing, syringe dispensing, and like print methods, or a combination thereof.

In embodiments, the curing of the applied curable formulation to the article can be accomplished by, for example, applying at least one of heat, light, such as infrared, UV, and like cure agents or methods, or a combination thereof.

In embodiments, the contacting of the pressure sensitive adhesive bearing side of the first member with a side of a second member to form the micro-article can be accomplished by, for example, applying a compressive force of from about 1,000 to about 20,000 psi. The pressure can be applied to a pre-assembly with, for example, a commercially available press, such as available from Norgren (www.norgrenfluid.com) having, for example, a 6 inch diameter cylinder with a 4 inch stroke (model no. A0333C1PS-6X4), or like devices. The pre-assembly article can be, for example, a securely held and oriented combination of the first member having the pressure sensitive adhesive on one side and the side of the second member. The pre-assembly article can be, for example, an intermediate product that can be further modified with, for example, surface treatments or liquid handling accessories. The pre-assembled article can also be, for example, the final product ready for immediate use or storage. In embodiments, thicker adhesive film dimensions can be selected and readily formed if desired, having thicknesses such as from about 0.1 inch to about 0.5 inch and thicker. Thicker adhesive film coats can be assembled with less compressive force of, for example, from about 50 to about 150 psi.

In embodiments, the curable formulation and its resulting fixed or cured pressure sensitive adhesive film layer can be, for example, a selectively formed discontinuous layer having, for example, a nominal layer thickness of from about 0.01 mm to about 5 mm. The curable formulation can be obtained commercially such as from 3M Corporation. Like formulations can be readily prepared using available adhesive polymer precursors, such as acrylate based formulations. There are number of curable formulations or printable PSA precursor formulations available having many variants, including for example heat or actinic radiation curable forms, non-out gassing formulations, no- or low-toxicity formulations, and like formulations.

Curable formulation can include, for example, at least one of a polymerizable monomer such as: acrylate, anhydride, glycidal ether, styrene, methyl vinyl ether, triethylene glycol methyl vinyl ether, butylvinyl ether, divinylbenzene, acrylamide, pyrrolidinone, dimethylacrylamide, or a combination thereof, such as homopolymers, copolymers, terpolymers, or like polymers. Copolymers, terpolymers, or like polymers can include, for example, random polymers, block polymers, gradient polymers, linear, branched, cross-linked, and like polymers. Examples of preferred polymers for the cured formulation can include, for example, polymethacrylate, polyacrylate, polystyrene, polybutadiene, polyisobutylene, polysilicone, polyurethane, synthetic rubber, natural rubber, and like polymers, or mixtures or copolymers thereof. These formulations can optionally be filled with nanopatricles such as silica, and like fillers, rheology modifiers, or like additives, to alter the physical properties of the pre-cure or curable formulation, or the post-cure fixed product.

In embodiments a preferred cured formulation can be, for example, a pressure-sensitive adhesive comprised of, for example, a rubber-like polymeric pressure-sensitive adhesive composition that includes as the base polymer thereof, a natural rubber, a synthetic rubber, for example, polyisoprene rubber, styrene-butadiene rubber, styrene-isoprene-styrene block copolymer rubber, styrene-butadiene-styrene block copolymer rubber, regenerated rubber, butyl rubber, polyisobutylene, styrene-ethylene-butylene-styrene, styrene-ethylene/butylene-styrene, styrene-ethylene/propylene, and like polymers or rubbers, or a mixture or a combination thereof.

In embodiments, a cured formulation can be, for example, an acrylic pressure-sensitive adhesive that comprises as the base polymer thereof, an acrylic polymer, including homopolymers, copolymers, terpolymers, and like combinations, one or more monomer of an alkyl(meth)acrylates. The alkyl(meth)acrylates for the acrylic pressure-sensitive adhesives can be, for example, a C₁₋₂₀ alkyl(meth) acrylate, such as methyl(meth)acrylate, ethyl(meth)acrylate, propyl(meth)acrylate, isopropyl(meth)acrylate, butyl(meth)acrylate, isobutyl(meth)acrylate, s-butyl(meth)acrylate, t-butyl(meth)acrylate, pentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate, eicosyl(meth)acrylate, and combinations thereof. These alkyl(meth)acrylates can be selected to provide intended or desired adhesiveness and cohesiveness of the resulting cured pressure-sensitive formulation.

In the curable formulation an alkyl(meth)acrylate monomer can optionally be copolymerized with any other copolymerizable monomer. The comonomer can include, for example, a carboxyl group-containing monomer and their corresponding anhydrides, such as (meth)acrylic acid, itaconic acid, maleic acid, fumaric acid, crotonic acid, isocrotonic acid; sulfonic acid group-containing monomers such as sodium vinylsulfonate; aromatic vinyl compounds such as styrene, substituted styrene; cyano group-containing monomers such as acrylonitrile; olefins and like unsaturated monomers such as ethylene, propylene, butadiene; vinyl esters such as vinyl acetate; vinyl chloride; amido group-containing monomers such as acrylamide, methacrylamide, N-vinylpyrrolidone, N,N-dimethyl(meth)acrylamide; hydroxyl group-containing monomers such as hydroxyalkyl(meth)acrylate, glycerin dimethacrylate; amino group-containing monomers such as aminoethyl(meth)acrylate, (meth)acryloylmorpholine; imido group-containing monomers such as cyclohexylmaleimide, isopropylmaleimide; epoxy group-containing monomers such as glycidyl(meth)acrylate, methylglycidyl(meth)acrylate; isocyanato group-containing monomers such as 2-methacryloyloxyethyl isocyanate. The comonomer can include, e.g., polyfunctional comonomers (polyfunctional monomers), such as triethylene glycol di(meth)acrylate, diethylene glycol di(meth)acrylate, ethylene glycol di(meth)acrylate, tetraethylene glycol di(meth)acrylate, neopentyl glycol di(meth)acrylate, 1,6-hexanediol di(meth)acrylate, trimethylolpropane tri(meth)acrylate, pentaerythritol tri(meth)acrylate, dipentaerythritol hexa(meth)acrylate, divinylbenzene, and like polyfunctional comonomers, and mixtures or copolymers thereof.

The curable formulation can be selected to provide a cured discontinuous layer having pressure sensitive adhesive properties and other suitable or desirable properties, such as being water-proof, water-repellant, water insoluble, non-hygroscopic, and like properties, to provide a robust finished article having wells or chambers that can be, for example, leak-proof, and substantially non-interacting and non-contaminating with samples or liquids that are contained-in or pass-through the wells or chambers.

The curable formulation can be readily and selectively applied, for example, by a liquid printing or like deposition methodology, to either a first or a second member and then be cured to transform the curable formulation to a pressure sensitive adhesive contact surface. Use of a printed curable formulation in the disclosed methods and article enables an improved manufacturing process that can be, if desired, easily automated and can provide improved efficiencies and cost savings by, for example, eliminating unnecessary steps, substantially increasing yields, and reducing discard scrap. In embodiments, the disclosed process can, for example, increase article yields by reducing failure or defect rates during plate assembly such as due to particulate contamination known as strings or threads where, for example, a pressure sensitive adhesive is directly applied to a work piece prior to bonding or joining opposing pieces. The disclosed process can be readily adapted and integrated into existing manufacturing systems and is highly scalable.

The disclosed process can also be used to make other articles or devices, for example, lab-on-a-chip devices, Transwell® permeable supports (available from Corning, Inc., Life Sciences; www.corning.com/lifesciences), microreactors, photocatalytic microreactors, diagnostic test strips incorporating a microfluidic channel, and like articles or plate products where contamination-free adhesive bonding of similar or dissimilar materials is involved.

In embodiments, the disclosed process provides a high level of control over adhesive characteristics and adhesive placement, such as flow, so that the adhesive cannot flow into, for example, well areas of the microplate assembly.

The articles and processes of the present disclosure are superior compared to articles and processes that employ adhesive systems based on, for example, a liquid which is printed on the plastic body, bonded to a glass insert, and then cured, or for example, a pressure sensitive adhesive (PSA) bearing sheet applied to the plastic body. Adhesive bonding of microplate components before curing the adhesive can lead to contamination of the sensing surface by, for example, the liquid adhesive spreading by wicking or wetting on to the sensing areas of the insert or plastic body.

In embodiments of the disclosure curing the curable formulation into a non-liquid pressure sensitive adhesive mass before bonding the grating to the insert provides a solid, or at least a non-spreading material, that cannot easily escape or diffuse into the sensing regions of a microplate and thus prevents occlusions or intrusions. In embodiments the viscosity of the curable formulation and the cured product can be manipulated to, for example, improve handling and processing characteristics, improve the finished article's properties or performance, and like considerations. The viscosity of the curable formulation and the cured product can be manipulated by, for example, changing or selecting adhesive application temperature, adhesive application speed, adhesive cure temperature, selection of carrier properties, selection of the monomer or the precursor composition, and like considerations.

In embodiments the disclosure provides a method for making a plate assembly, the plate comprising, for example, a plastic body, and a grating sensor. A curable formulation or liquid adhesive precursor can be applied to, for example, conform to a desired geometry of a well pattern or microfluidic channel(s) defined by the plastic body, for example by printing using various printing methods. The curable formulation is cured to form a solid or non-flowing pressure sensitive adhesive on the plastic body. Next, the plastic body bearing the cured formulation, such as the non-flowing printed pressure sensitive adhesive, is joined-with or bonded-to the grating sensor member using pressure.

In embodiments, the disclosure provides a method for plate assembly that cures the adhesive before bonding. Consequently, the adhesive cannot diffuse into the sensing regions to cause contamination or occlusion. The alignment of the adhesive and well pattern is considerably neater and easier to control in the disclosed process compared to alternative processes. For example, when the plate assembly process is accomplished using a pressure sensitive adhesive sheet, it is difficult to apply the pressure sensitive adhesive sheet to a plurality of complex and small dimensioned well plate shapes where the pressure sensitive adhesive sheet must be closely aligned with the well plate. The pressure sensitive adhesive sheet can get distorted or disoriented resulting in a finished plate article having adhesive sheet intrusion into the sensing region causing occlusion defects, see for example, U.S. Pat. No. 7,175,980 (die-cut PSA sheet), and US Pat Pub 2007/0141231. Other bonding approaches have applied an adhesive formulation to a member, followed by combining with a second member before curing the adhesive formulation that bonds the members together, see for example, U.S. Pat. No. 7,005,029 and U.S. Pat. No. 5,948,673. This latter approach may be disadvantaged by having to use, for example, transparent members in combination with radiation curing.

A thin layer of a pressure sensitive adhesive precursor can be, for example, having a thickness of, for example, from about 0.001 inch to about 0.1 inch, from about 0.001 to about 0.005 inch, from about 0.001 to abut 0.003 inch, and from about 0.001 to about 0.002 inch. Thicker layers are acceptable so long as the adhesive does not interfere with the article function, i.e., no well intrusion or no adverse impact or distortion of the dimensions of a well, a cell, a channel, or a chamber, such as encountered with adhesive excursions or incursions that may distort or encroach into a well, a cell, a channel, or a chamber. In embodiments, the curable formulation that produces a pressure sensitive adhesive, can be applied to, for example, a plastic well member (“holey plate”) of the microplate by, for example, screen printing, pad printing, edge printing, and like print, dispense, or deposition methods, to form a printed pattern or like pattern that corresponds to areas other than or outside the wells or microfluidic channels in the finished article or device. U.S. Pat. No. 6,883,908, mentions methods and compositions for ink jet printing of pressure sensitive adhesive patterns or films on a wide range of substrates using a curable formulation.

The member, such as a glass or plastic part, having the printed pattern of curable formulation can be energetically cured, for example, by heat, actinic radiation such as infrared or UV radiation, e-beam radiation, microwave radiation, and like radiation sources, to form an active pressure sensitive adhesive. The cured formulation can have a thickness that is substantially the same thickness as the printed or deposited curable formulation, after any initial spreading or leveling, if any, so that there is substantially little or no shrinkage or swelling of the cured film to distort the film thickness dimensions. The part having the positioned fixed pressure sensitive adhesive can be bonded to a sensor grating member under pressure to produce a finished plate assembly having wells or liquid handling areas that are substantially free of adhesive or curable formulation residues. The printed pressure sensitive adhesive composition provides bonding to securely join together plate member components and to seal the resulting liquid chambers to prevent well leakage or well-to-well cross-contamination.

### EXAMPLES

The following examples serve to more fully describe the manner of using the above-described disclosure, and to set forth examples of the best modes contemplated for carrying out various aspects of the disclosure. It is understood that these examples do not limit the scope of this disclosure, but rather are presented for illustrative purposes.

### Example 1

### Preparation of a Microtiter Plate

Process Steps and Conditions Referring to the Figures, FIG. 1 provides an exemplary schematic for the preparation of a micro-article of the disclosure. A first member (100), such as a base member or a liquid holding portion of a well plate or a microfluidic article, can be selectively printed (110), for example, using edge printing methods, with a suitable curable formulation and then cured (120) to afford the base plate having the cured selectively printed formulation as a discontinuous layer in distinct regions or geometries (121), such as rings, open triangles, open squares, and like shapes. One alternative for selective printing of the curable formulation can include, for example, a full or partial grid pattern (122), or a regular pattern of spots or beads (123), for example, with or with interconnecting grid lines, and like patterns, or combinations thereof. A spot or beaded pattern (123) without one or both sets of grid lines, although workable, may be less effective in sealing each and every cell or well against leakage. The first member bearing the printed and cured formulation is bonded (130) with a second member, such as a microtiter well plate (135) with, for example, the application of high pressure, such as applied in a press, to afford a micro-article (140) assembly. The microtiter well plate can include various well geometry openings (136) or shapes, which openings can correspond to but are not co-extensive with or inclusive of the geometries of the printed and cured formulation (121). Preferably the well openings have a smaller size to avoid encroachment of the cured matter or bond seal (139) into either the well region (137) or the sensor region on the base member (100) within the well region.

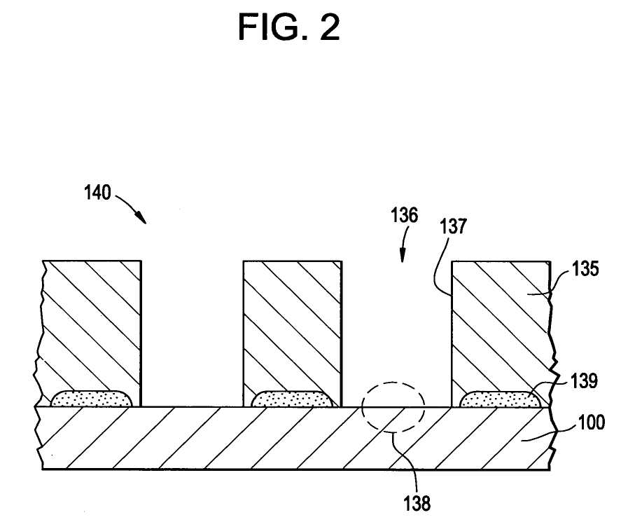

FIG. 2 shows a cross-section of the article (140) of FIG. 1 about section line A-A (for illustration only; component and dimensions not drawn to scale). Again, the microtiter well plate having various well geometry openings (136) or shapes correspond to but are not co-extensive with or inclusive of the geometries of the printed and cured formulation (121) nor the corresponding seal (139) resulting from bonding the base plate (100) and the well plate (135) members together. The wells (137) are smaller in size to avoid encroachment of the cured matter or bond seal (139) into either the well region or the sensor region (138) situated within the well region.

Microscopic Photographic Evidence of Adhesive Residue-Free Wells The following describes a microscopic analysis of a microplate article to demonstrate absence or minimization of adhesive residue in the well or liquid holding region. Microplates, such as 384-well plates, were assembled according to the present disclosure and according to a related comparative process, having a number of disadvantages. Individual wells in the resulting plates were imaged using a Nikon Eclipse light microscope equipped with an image capture system. The imaging was accomplished with a view from above the well opening using transmitted light from below.

In embodiments of the disclosed process microplates were assembled by, for example: printing an adhesive precursor onto well-plate; curing the adhesive precursor to it; combining the pressure sensitive adhesive bearing well-plate with a grating; and applying pressure to the combined pressure sensitive adhesive bearing well plate with the grating to complete the attachment or bonding and form a ready-to-use well plate article. Photographs (not included) of the wells of the finished articles of the disclosed process showed no adhesive or like residue in the wells, such as at the periphery of the well or elsewhere. Thus, the disclosed process, unlike the comparative process mentioned below, enables the assembly of plates and like articles without contaminating materials, such as adhesive or its cured product entering into optically sensitive areas of the article such as the well or region where the biosensor resides.

In a comparative process plates were assembled according to: an adhesive printing step that included pad printing a pressure sensitive adhesive onto a well plate; a bonding step that combined the adhesive bearing well plate with a grating with pressure; and a curing step to cure or solidify the adhesive situated between the well plate and the grating member. In this process the bonding step resulted in a final microplate article having a defect of the adhesive being pressed into the well area. Additional comparative photographic images (not shown) of wells having an average diameter of about 80 microns showed distinctive intrusion of the adhesive into the wells, such as at the periphery or circumference of the well of, for example about 1 to 4 microns.

### Example 2

Preparation of an Epic® Biosensor Microplate The process of Example 1 was repeated with the exception that a first member, such as an Epic® holey-plate, was selectively printed on the circumference of the wells with the adhesive precursor using edge printing or pad printing. The printed part was cured by heat, radiation, or a combination thereof, to transform the adhesive precursor formulation as a viscous liquid into a solidified, that is a non-flowing, pressure sensitive adhesive substance. After curing, the holey-plate was bonded using pressure to a resonant wave guide base plate including a biosensor. Accomplishing the curing on the holey-plate before combining the holey-plate with the base plate can avoid contamination or distortion of the biosensor.

### Example 3

Preparation of a Microreactor The process of Example 1 was repeated with the exception that a silk screen is made corresponding to the desired microreactor fluid flow patterns. Adhesive precursor was printed on selected areas of one member of the microreactor using the silk screen. The printed member was heated or irradiated to cure the adhesive precursor to transform it into a solid pressure sensitive adhesive. This member was then bonded to the other half of the microreactor using pressure. In embodiments, the curable formulation and material for forming a reference patch can be printed, for example at the same time, or in sequential steps using the same or different printing equipment, to form, for example, a microreactor having a frame including a plurality of liquid holding regions or chambers formed therein, each well incorporating a biosensor having a surface with a reference region and a sample region. An example of a microreactor or microplate structure and method of making is disclosed in commonly owned U.S. patent application Ser. No. 11/784,130, filed Apr. 5, 2007 and entitled “Closed Flow-Through Microplate and Methods for Using and Manufacturing Same.”

Microscopic Photographic Evidence of Adhesive Residue-Free Wells The following describes a microscopic analysis of a microreactor article prepared by the foregoing process to demonstrate absence or minimization of adhesive residue in the liquid holding region or chamber.

A microreactor, such as 96-well label independent detection plate was assembled according to the present disclosure and separately according to a related but disadvantaged comparative process. Individual wells, a pairing of wells such as adjacent wells (photo image not included) in whole or part, or a group of wells in the resulting plates could be imaged using a Nikon Eclipse light microscope equipped with an image capture system. The imaging was accomplished with a view from above the well opening using transmitted light from below. Each well region appears as light gray. The cured and bonded adhesive region appears as a distinct light colored surround. Each well and its adhesive surround is separated from adjacent wells by a distinct adhesive-free area referred to as the inter-well region.

### Example 4

Preparation of a Permeable Support Microwell Plate The process of Example 1 can be repeated with the exception that a first member, such as a Transwell® plate (commercially available from Coming Inc.), is selectively printed on the circumference of the wells with the curable adhesive precursor using, for example, edge printing or pad printing. The printed part is cured by heat or radiation to transform the viscous liquid adhesive precursor into a solidified pressure sensitive adhesive. After curing, the well plate is bonded to a porous membrane under pressure to provide the permeable support microwell plate free of adhesive residue excursions or intrusions.

The disclosure has been described with reference to various specific embodiments and techniques. However, many variations and modifications are possible while remaining within the spirit and scope of the disclosure.

What is claimed is:

1. A method for making a micro-article, the method comprising:
applying a curable formulation to at least one selected area on one side of a first member;
curing the curable formulation to provide a pressure sensitive adhesive at the at least one selected area on the first member; and
contacting the pressure sensitive adhesive side of first member with a side of a second member to form the micro-article.

2. The method of claim 1 wherein the micro-article comprises a microplate, a biosensor, a microfluidic cell, a micro-reactor, a cell culture vessel, or a combination thereof.

3. The method of claim 1 wherein the first member comprises a liquid holder, microtiter plate, a sensor grating, or a combination thereof, the second member comprises a sensor grating, a liquid holder, microtiter plate, or a combination thereof.

4. The method of claim 3 wherein the surfaces of the liquid holder and the sensor grating of the resulting micro-article are substantially free of curable formulation, pressure sensitive adhesive, or a combination thereof.

5. The method of claim 1 wherein applying a curable formulation to at least one selected area on one side of a first member comprises using at least one of screen printing, pad printing, edge printing, pin printing, ink jet printing, jet dispensing, syringe dispensing, or a combination thereof.

6. The method of claim 1 wherein applying a curable formulation to at least one selected area on one side of a first member comprises forming at least one of a grid-like pattern, a spot array, a shaped geometrical array, or a combination thereof.

7. The method of claim 1 wherein curing the curable formulation comprises applying at least one of heat, actinic radiation, or a combination thereof.

8. The method of claim 1 wherein the cured formulation affording a pressure sensitive adhesive retains its dimensional integrity in the resulting micro-article.

9. The method of claim 1 wherein contacting the pressure sensitive adhesive side of the first member with a side of a second member to form the micro-article comprises applying compressive force of from about 1,000 to about 20,000 psi to an assembly comprising the first member having the pressure sensitive adhesive on one side with the side of the second member.

10. The method of claim 1 wherein the curable formulation and the resulting pressure sensitive adhesive comprise a discontinuous layer having a nominal layer thickness of from about 0.01 mm to about 5 mm.

11. The method of claim 1 wherein the curable formulation comprises at least one polymerizable monomer selected from an acrylate, an unsaturated anhydride, a glycidal ether, an unsaturated aryl substituted monomer, an alkyl vinyl ether, an alkylene glycol alkyl vinyl ether, a divinyl aryl monomer, an acrylamide, a pyrrolidinone, a dialkylacrylamide, or a combination thereof.

12. The method of claim 1 wherein the curable formulation comprises a printable precursor of a pressure sensitive adhesive comprising at least one of a monomer, a pre-polymer, an oligomer, a cross-linkable polymer, a combination thereof, or a copolymer thereof.
